(19) United States
(12) Patent Application Publication
(10) Pub. No.: US 2020/0141141 A1
(43) Pub. Date: May 7, 2020

(54) SUBFLOOR LEVELING ASSEMBLY

(71) Applicant: Jose Mario Diaz, La Puente, CA (US)

(72) Inventor: Jose Mario Diaz, La Puente, CA (US)

(21) Appl. No.: 16/177,928

(22) Filed: Nov. 1, 2018

(51) Int. Cl. E04G 23/02; E04F 21/20; C09J 11/08; C09J 201/00

(52) U.S. Cl. CPC E04G 23/0285; E04F 21/20; E04F 15/0215; C09J 201/00; C09J 11/08

(57) ABSTRACT

A subfloor leveling assembly for leveling floor paneling on a subfloor includes a subfloor of a floor system in a building. A leveling compound is provided that comprises wood particles that are mixed with a fluid resin. The leveling compound is spread over the subfloor to completely cover the subfloor thereby facilitating the leveling compound to settle through gravity. In this way the leveling compound defines a level surface on the subfloor. Floor paneling is provided and the floor paneling is positionable on the leveling compound when the leveling compound is spread over the subfloor. In this way the floor paneling is leveled on the subfloor.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to leveling devices and more particularly pertains to a new leveling device for leveling floor paneling on a subfloor.

### BRIEF SUMMARY OF THE INVENTION

An embodiment of the disclosure meets the needs presented above by generally comprising a subfloor of a floor system in a building. A leveling compound is provided that comprises wood particles that are mixed with a fluid resin. The leveling compound is spread over the subfloor to completely cover the subfloor thereby facilitating the leveling compound to settle through gravity. In this way the leveling compound defines a level surface on the subfloor. Floor paneling is provided and the floor paneling is positionable on the leveling compound when the leveling compound is spread over the subfloor. In this way the floor paneling is leveled on the subfloor.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a box and a container of a subfloor leveling assembly according to an embodiment of the disclosure.

FIG. 2 is an exploded perspective view of an embodiment of the disclosure.

### DETAILED DESCRIPTION OF THE INVENTION

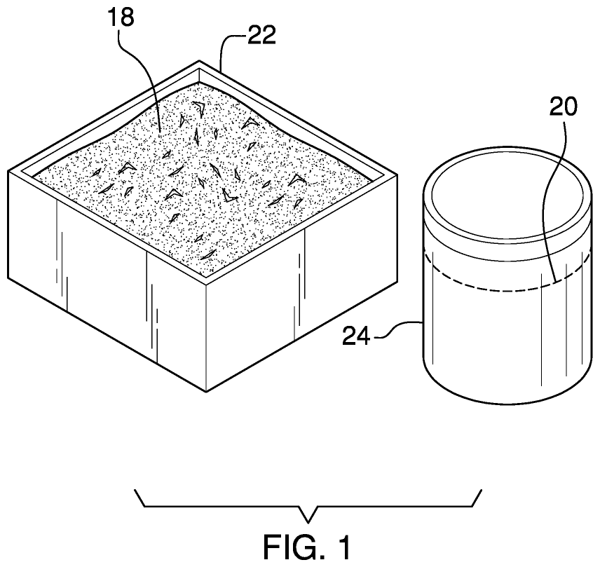

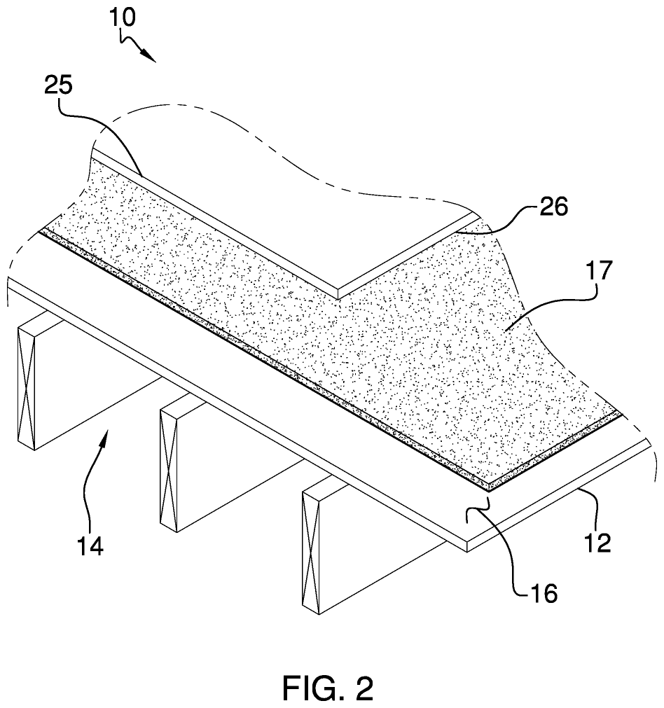

With reference now to the drawings, and in particular to FIGS. 1 through 2 thereof, a new leveling device embodying the principles and concepts of an embodiment of the disclosure and generally designated by the reference numeral 10 will be described.

As best illustrated in FIGS. 1 through 6, the subfloor leveling assembly 10 generally comprises a subfloor 12 of a floor system 14 in a building. The subfloor 12 has a top surface 16 and the subfloor 12 may be wood panel subflooring of any conventional design commonly employed in the construction industry. A leveling compound 17 is provided that comprises wood particles 18 that are mixed with a fluid resin 20. The wood particles 18 may be sawdust, wood shavings or any other type of particulate matter comprised of wood. The fluid resin 20 may be a self levelling and adhesive fluid resin. The subfloor 12 may be existing subfloor in a building that has suffered from structural settling or other forces that have rendered the subfloor un-level.

The leveling compound 17 is spread over the top surface 16 of the subfloor 12 to completely cover the subfloor 12. In this way the leveling compound 17 can settle through gravity thereby defining a level surface on the subfloor 12. A box 22 is provided for containing the wood particles 18 and a container 24 is provided for containing the fluid resin 20. The fluid resin 20 is added to the wood particles 18 in the box 22 in a predetermined amount thereby facilitating the leveling compound 17 to be created in the box 22. The container 24 may be a jar with a lid or other air tight container 24 capable of storing the fluid resin 20 over a long duration of time.

Floor paneling 25 is positionable on the leveling compound 17 when the leveling compound 17 is spread over the subfloor 12. In this way the floor paneling 25 can be leveled on the subfloor 12 without requiring the subfloor 12 to be leveled through approved reconstruction practices such as floor jacking or the like. The floor paneling 25 has a bottom surface 26 and the bottom surface 26 contacts the leveling compound 17 when the floor paneling 25 is positioned on the leveling compound 17. The floor paneling 25 may be wood floor paneling of any conventional design that is common to the construction industry.

In use, the wood particles 18 are collected and poured into the box 22. A predetermined amount of the fluid resin 20 is poured into the box 22 and the fluid resin 20 is mixed with the wood particles 18. In this way the leveling compound 17 is formed in the box 22 for subsequent spreading over the top surface 16 of the subfloor 12. The floor paneling 25 is laid on the leveling compound 17 once the leveling compound 17 has been applied to the subfloor 12 and the leveling compound 17 has rested for a sufficient amount of time to self-level. In this way the floor paneling 25 can be leveled on the subfloor 12 without requiring re-construction of the subfloor 12, joists, beams and columns of the floor system 14 in the building. Additionally, the leveling compound 17 adheres to the bottom surface 26 of the floor paneling 25 for enhancing fastening the floor paneling 25 to the subfloor 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A subfloor leveling assembly for leveling and adhering floor paneling to a subfloor, said assembly comprising:
a subfloor of a floor system in a building;
a leveling compound comprising wood particles being mixed with a fluid resin, said leveling compound being spread over said subfloor to completely cover said subfloor thereby facilitating said leveling compound to settle through gravity wherein said leveling compound is configured to define a level surface on said subfloor; and
floor paneling being positionable on said leveling compound when said leveling compound is spread over said subfloor wherein said floor paneling is configured to be leveled on said subfloor.

2. The assembly according to claim 1, wherein:
said subfloor has a top surface; and
said leveling compound is spread over said top surface of said subfloor.

3. The assembly according to claim 1, further comprising:
a box for containing said wood particles; and
a container containing said fluid resin, said fluid resin being added to said wood particles in said box in a predetermined amount thereby facilitating said leveling compound to be created in said box.

4. The assembly according to claim 2, wherein said floor paneling has a bottom surface, said bottom surface contacting said leveling compound when said floor paneling is positioned on said leveling compound.

5. A subfloor leveling assembly for leveling and adhering floor paneling to a subfloor, said assembly comprising:
a subfloor of a floor system in a building, said subfloor having a top surface;
a leveling compound comprising wood particles being mixed with a fluid resin, said leveling compound being spread over said top surface of said subfloor to completely cover said subfloor thereby facilitating said leveling compound to settle through gravity thereby defining a level surface on said subfloor;
a box for containing said wood particles;
a container containing said fluid resin, said fluid resin being added to said wood particles in said box in a predetermined amount thereby facilitating said leveling compound to be created in said box; and
floor paneling being positionable on said leveling compound when said leveling compound is spread over said subfloor wherein said floor paneling is configured to be leveled on said subfloor, said floor paneling having a bottom surface, said bottom surface contacting said leveling compound when said floor paneling is positioned on said leveling compound.
